(19) United States
(12) Patent Application Publication
(10) Pub. No.: US 2004/0126650 A1
(43) Pub. Date: Jul. 1, 2004

(54) Electrode assembly for lithium ion cell and lithium cell using the same

(75) Inventor: Chang-Seob Kim, Cheonan-city (KR)

Correspondence Address: McGuireWoods LLP, Suite 1800, 1750 Tysons Boulevard, McLean, VA, 22102, US

(73) Assignee: Samsung SDI Co., Ltd.

(21) Appl. No.: 10/667,602

(22) Filed: Sep. 23, 2003

(30) Foreign Application Priority Data
Sep. 23, 2002 (KR) 10-2002-0057638

(51) Int. Cl. H01M 2/26; H01M 2/34

(52) U.S. Cl. 429/61; 429/161

(57) ABSTRACT

An electrode assembly for a lithium ion cell and a lithium ion cell using the electrode assembly are provided. The electrode assembly for a lithium ion cell includes a positive electrode plate, a separator and a negative electrode plate, which are sequentially stacked and wound. A positive electrode lead is electrically coupled to the positive electrode plate and is led from the positive electrode plate. A negative electrode lead is electrically coupled to the negative electrode plate and has a current interrupter which is capable of causing a disconnection in the event of an over-current.

### CROSS REFERENCE TO RELATED APPLICATION

This application claims the priority of Korean Patent Application No. 2002-57638, filed on Sep. 23, 2002, in the Korean Intellectual Property Office, the disclosure of which is incorporated herein in its entirety by reference.

### BACKGROUND OF THE INVENTION

1. Field of the Invention

The invention relates to an electrode assembly for a lithium ion cell and a lithium ion cell using the same, and more particularly, to an electrode assembly for a lithium ion cell having improved current blocking means for protecting the lithium ion cell from an over-current condition and a lithium ion cell using the same.

2. Description of the Related Art

In general, secondary batteries are capable of recharging, achieving miniaturization and having a large energy capacity. The development of portable electronic devices such as cellular phones, notebook computers or camcorders has lead to increased research in secondary batteries as power sources for portable electronic devices. Secondary batteries include, for example, nickel-cadmium (Ni—Cd) batteries, nickel-metal hydride (Ni—MH) batteries, lithium-hydrogen (LiH) batteries, and lithium secondary batteries. Specifically, lithium secondary batteries operating at 3.6 V are rapidly developing in view of their excellent energy density per unit weight compared to the nickel-cadmium Ni—Cd batteries or nickel-hydride Ni—MH batteries.

Lithium secondary batteries may be classified as liquid electrolyte cells and polymer electrolyte cells based on the kind of electrolyte used. Batteries using a liquid electrolyte are generally referred to as lithium-ion batteries, and batteries using a polymer electrolyte are referred to as lithium-polymer batteries. Lithium secondary batteries are manufactured in various shapes, such as, cylindrical and rectangular shapes. In recent years, lithium polymer cells have been manufactured in a pouch type. Such a pouch type battery is flexible.

However, lithium secondary batteries have several problems in terms of safety. In a lithium ion cell, a lithium oxide may be used for a positive electrode active material, a carbon material may be used as a negative electrode active material and an organic electrolyte solvent may be used as an electrolytic solution. In such a lithium ion cell, when the cell is overcharged, the electrolytic solution may decompose at the positive electrode and metallic lithium may precipitate at the negative electrode. As the result, battery characteristics may deteriorate and there is a risk of overheating and/or fire. Also, when the cell is overcharged, electrochemical reactions may cause various exothermic reactions at the same time, and a solid electrolyte interface (SEI) layer of a negative electrode may decompose and release gas, thereby causing swelling of a battery and making the internal state of the battery unstable. Under these circumstances, the battery may rupture or explode.

To overcome such problems, various methods have been proposed, including installation of a current interrupter which is capable of reducing current in the event of an over-current.

FIG. 1 is a schematic cross-sectional view of a conventional rectangular lithium ion cell.

Referring to FIG. 1, a lithium ion cell 10 is constructed such that a battery unit 11, having a positive electrode, a separator and a negative electrode sequentially stacked and wound, is housed in a can 12. The can 12 is connected to the positive electrode, and a cap assembly 13 is installed above the can 12. The can 12 and the cap assembly 13 are then sealed to each other by welding. Insulating plates 14 are installed in the upper and lower portions of the battery unit 11 in order to prevent the battery unit 11 from contacting the cap assembly 13 and the can 12.

The cap assembly 13 includes a positive electrode plate 15 and a negative electrode plate 16. The positive electrode plate 15 is welded to an upper portion of the can 12. The negative electrode plate 16 is disposed, for example, at the center of the cap assembly 13. An insulating plate 17 is installed between the positive electrode plate 15 and the negative electrode plate 16. A rivet 18 penetrates through the central portion of the positive electrode plate 15 and is electrically coupled to the negative electrode of the battery unit 11 and a lead 19. The rivet 18 is insulated from the positive electrode plate 15 by a separator gasket 21.

In the lithium ion cell having the aforementioned configuration, a non-aqueous electrolytic solution is injected into the cell through an inlet 22 which is formed at the positive electrode plate 15. A plug is inserted into the inlet 22 and welded for hermetically sealing.

In order to prevent explosion of a lithium ion cell due to an abnormal increase in internal pressure, a safety vent 23 having grooves formed, for example, by a mechanical method, etching or electric molding is provided at the positive electrode plate 15 of the cap assembly 13.

When such a lithium ion cell is shorted from the outside by a conductive material, an over-current may flow therein, resulting in thermal runway, so that there is risk of explosion. To overcome this problem, as shown in FIG. 2, a current limiter 25 is installed on the bottom surface of a can 24, thereby securing safety against explosion. When the lithium ion cell is heated, an electric conducting property of the current limiter 25 is sharply reduced by heat, thereby preventing explosion of the cell. In the case of a cylindrical secondary battery in which a cap assembly is crimped at the upper portion of a can, the current limiter 25 can be installed inside the cell. In the case of a rectangular secondary battery in which a cap assembly and a can are welded by laser, the current limiter 25 can be installed outside the cell, as shown in FIG. 2. Thus, for a unit cell, the rectangular secondary battery has an additional component. As a result, the effective height of the battery is reduced by the height of the current limiter 25. Accordingly, although safety against an over-current is secured, a capacity of the conventional rectangular secondary battery is reduced. Also, since the current limiter is exposed outside the cell, the conventional rectangular secondary battery is structurally unstable. Further, in order to install such a current limiter, a separate process, for example, welding between the current limiter and a cap assembly, is necessary, or a cap assembly support member may be used, which result in poor manufacturability.

Korean Patent Publication No. 1999-84594 discloses a battery having a recessed current limiter installed at a negative electrode plate, by which a capacity of a battery can be maintained without being reduced. However, the disclosed battery still has at least one problem in that it requires a separate process for installing a current limiter.

### SUMMARY OF THE INVENTION

The invention provides an electrode assembly for a lithium ion cell having improved current interrupting means, by which a capacity of the cell can be increased while maintaining its safety, and a lithium ion cell using the electrode assembly.

In an aspect of the present invention, there is provided an electrode assembly for a lithium ion cell, comprising a battery unit having a positive electrode plate, a separator and a negative electrode plate sequentially stacked and wound, a positive electrode lead electrically that is connected to the positive electrode plate and is led from the positive electrode plate. The electrode assembly also includes a negative electrode lead that is electrically coupled to the negative electrode plate, which is led from the negative electrode plate, and a current interrupter disconnected in the event of an over-current.

In accordance with another aspect of the present invention, there is provided a lithium ion cell comprising an electrode assembly for a lithium ion cell comprising a battery unit having a positive electrode plate, a separator and a negative electrode plate sequentially stacked and wound. The electrode assembly further includes a positive electrode lead that is electrically connected to the positive electrode plate and is led from the positive electrode plate, a negative electrode lead that is electrically coupled to the negative electrode plate and has a current interrupter which causes disconnection when an over-current flows. A can accommodes the electrode assembly, and a cap plate is welded to the upper end of the can and has a negative electrode terminal which is electrically coupled to a negative electrode lead of the electrode assembly.

### BRIEF DESCRIPTION OF THE DRAWINGS

The above aspect and advantages of the present invention will become more apparent by describing in detail preferred embodiments thereof with reference to the attached drawings.

FIG. 1 is a schematic cross-sectional view of a conventional lithium ion cell.

FIG. 2 is a schematic plan view of a current limiter of the conventional lithium ion cell shown in FIG. 1.

FIG. 3 is a perspective view of an electrode assembly of a lithium ion cell according to an embodiment of the present invention.

FIG. 4 is an exploded perspective view of an electrode assembly of the lithium ion cell shown in FIG. 3.

FIG. 5A is a partially enlarged view of a first embodiment of a portion “A” shown in FIG. 3.

FIG. 5B is a partially enlarged view of a second embodiment of the portion “A” shown in FIG. 3.

FIG. 5C is a partially enlarged view of a third embodiment of the portion “A” shown in FIG. 3.

FIG. 5D is a partially enlarged view of a fourth embodiment of the portion “A” shown in FIG. 3.

FIG. 5E is a partially enlarged view of a fifth embodiment of the portion “A” shown in FIG. 3.

FIG. 5F is a partially enlarged view of a sixth embodiment of the portion “A” shown in FIG. 3.

FIG. 6A is a cross-sectional view of a rectangular lithium ion cell according to the present invention,

FIG. 6B is an exploded perspective view of the rectangular lithium ion cell shown in FIG. 6A.

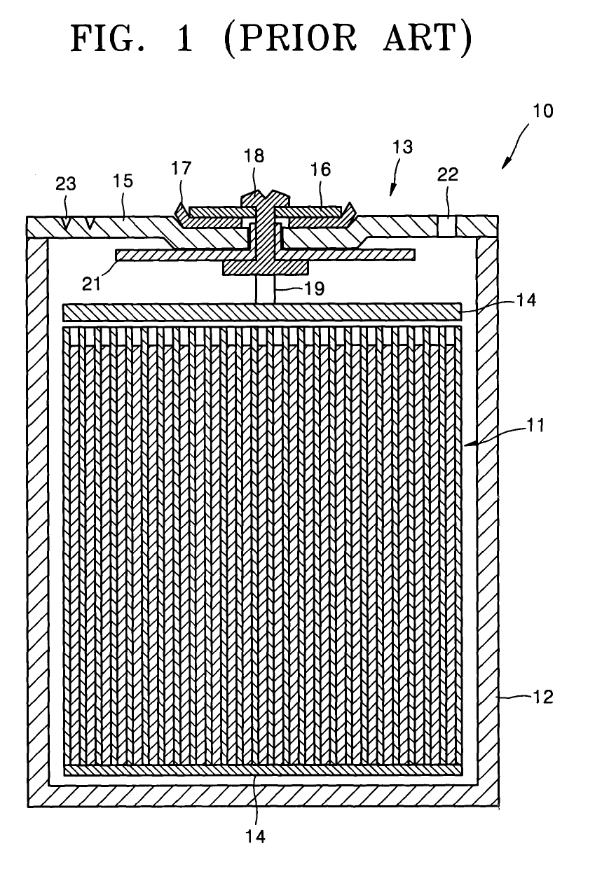

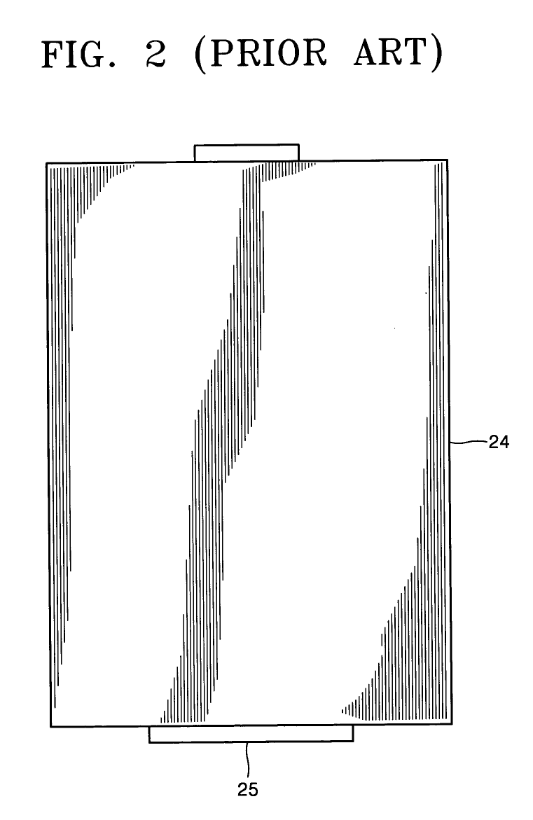

### DETAILED DESCRIPTION OF THE INVENTION

Preferred exemplary embodiments of the present invention will now be described in detail with reference to the accompanying drawings.

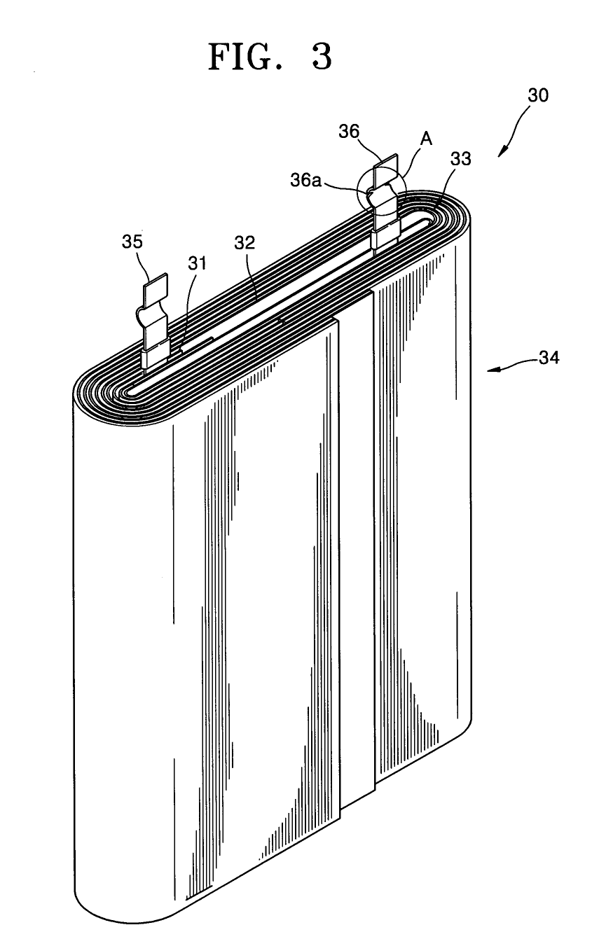

FIG. 3 is a perspective view of an electrode assembly of a lithium ion cell according to an embodiment of this invention.

Referring to FIG. 3, an electrode assembly 30 includes a battery unit 34 having a positive electrode plate 31, a separator 32 and a negative electrode plate 33 sequentially stacked and wound. A positive electrode lead 35 is electrically coupled to the positive electrode plate 31 and is led from the positive electrode plate 31. A negative electrode lead 36 is electrically coupled to the negative electrode plate 33 and is led from the negative electrode plate 33. A current interrupter 36a is provided at negative electrode lead 36 and is disconnected when an over-current flows. The current interrupter 36a has a cross-sectional area smaller than that of an adjacent portion so that it serves as a resistor when an over-current flows. When an over-current flows, heat is generated. Accordingly, the current interrupter 36a partially melts, resulting in disconnection, and thereby shutting off an over-current.

FIG. 4 is an exploded perspective view of a jelly-roll configuration of a battery unit used in an electrode assembly according to the present invention.

Referring to FIGS. 3 and 4, the positive electrode plate 31 includes a positive electrode current collector 31a made of a sheet or strip-shaped piece of metal foil and a positive electrode active material layer 31b which is coated on at least one surface of the positive electrode current collector 31a. The positive electrode current collector 31a may be made, for example, of an aluminum foil having good conductivity. As the positive electrode active material layer 31b, a composition comprising a lithium oxide, a binder, a plasticizer and a conductive material may be used. On the positive electrode plate 31, a positive electrode lead 35 is attached to a positive electrode uncoated area 31c, and a protective tape 35a having a predetermined width is wrapped around the outer surface at the edge of the positive electrode lead 35.

The negative electrode plate 33 includes a negative electrode current collector 33a made of a sheet or strip-shaped piece of a metal foil and a negative electrode active material layer 33b coated on at least one surface of the negative electrode current collector 33a. The negative electrode current collector 33a may be made, for example, of a copper foil having good conductivity. As the negative electrode active material layer 33b, a composition comprising a carbon material as a negative electrode active material, a binder, a plasticizer and a conductive material may be used. On the negative electrode plate 33, a negative electrode lead 36 is attached to a negative electrode uncoated area 33c. The protective tape 35a is also wrapped around the outer surface at the edge of the negative electrode lead 36.

The positive electrode lead 35 and the negative electrode lead 36 are electrically coupled to surfaces of the positive electrode uncoated area 31c and the negative electrode uncoated areas 33c, respectively. To this end, the positive and negative electrode leads 35 and 36 are attached to the positive electrode uncoated are 31c and the negative electrode uncoated areas 33c by, for example, welding, e.g., laser welding or ultrasonic welding, or by using a conductive adhesive agent such that there is an electrical connection.

The positive electrode plate 31, the separator 32 and the negative electrode plate 33 are wound in a roll, like a jellyroll and form the battery unit 34.

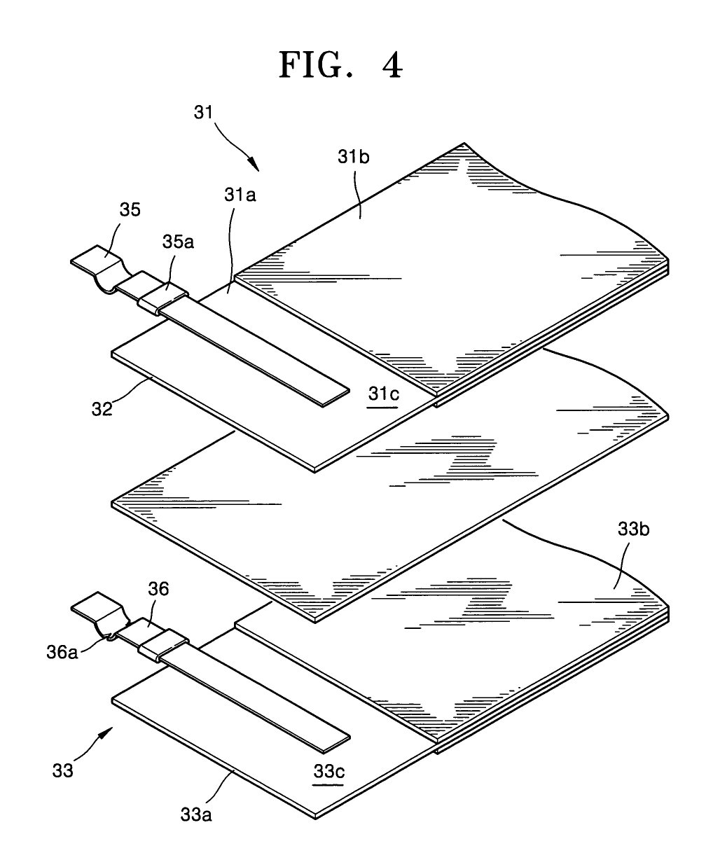

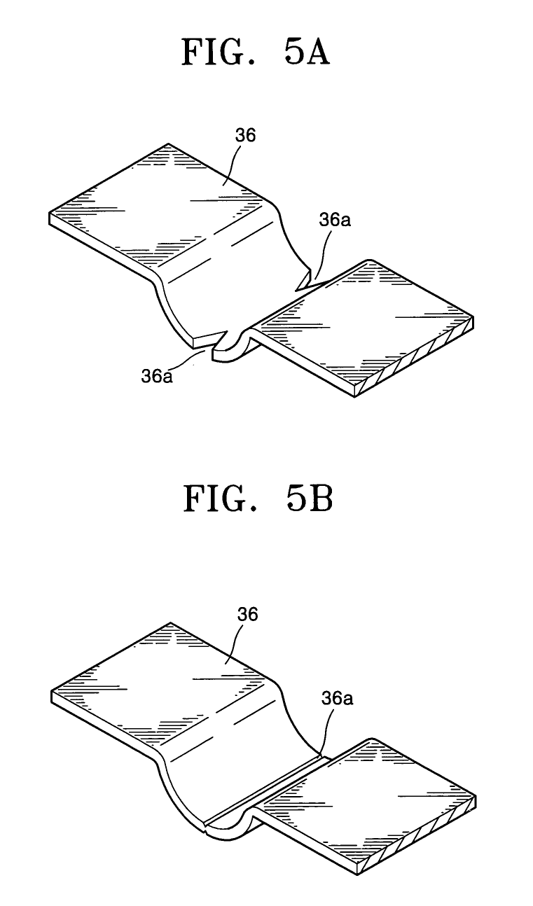

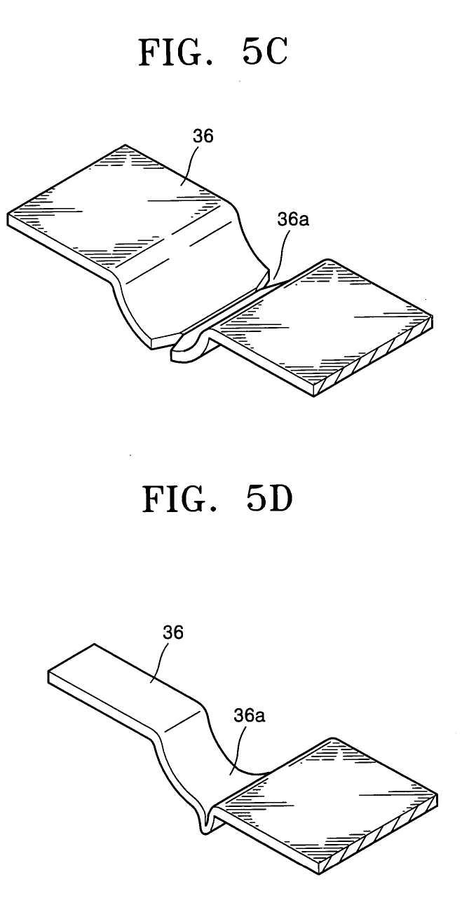

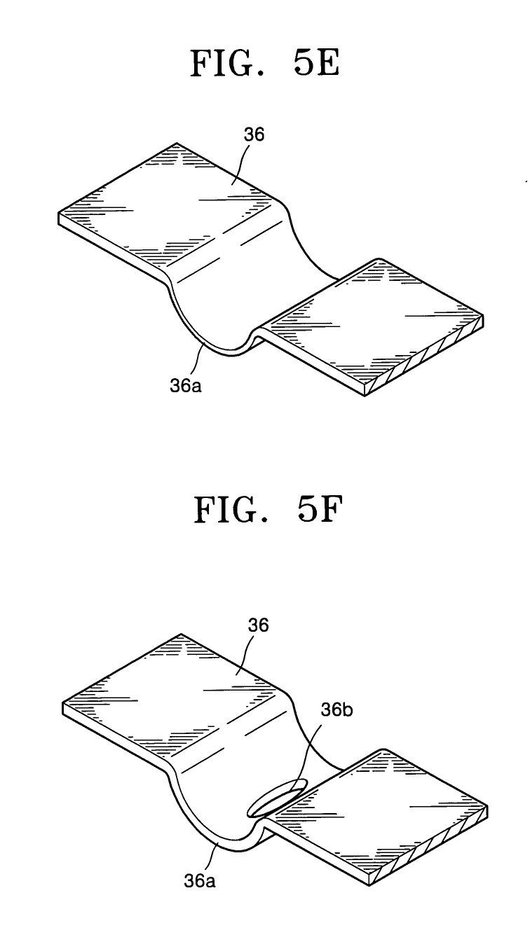

FIG. 5A is an enlarged view of a portion “A” shown in FIG. 3. Referring to FIG. 5A, because the current interrupter 36a of the negative electrode lead 36 has a reduced cross-sectional area, disconnection may occur in the event of an over-current. According to this embodiment, in order to reduce the cross-sectional area, notches are formed along an edge of the negative electrode lead 36. The notches may be formed opposite to one another along both edges of the negative electrode lead 36.

Referring to FIG. 5B another exemplary embodiment of the current interrupter 36a is shown. In this exemplary embodiment, the negative electrode lead 36 has trenches along a surface of the negative electrode lead 36. The trenches may be formed opposite to one another across both surfaces of the negative electrode lead 36. As shown in FIG. 5B, the trenches reduce the cross-sectional area of the negative electrode lead 36 in the region where the trenches are located.

Referring to FIG. 5C, the cross-sectional area of the current interrupter 36a is reduced by forming at least one notch on the edge of the negative electrode lead 36 and at least one trench along a surface of the negative electrode lead 36. The notches may be formed opposite to one another along both edges of the negative electrode lead 36 and the trenches may be formed opposite to one another across both surfaces of the negative electrode lead 36.

Referring to FIG. 5D, the cross-sectional area of the current interrupter 36a is reduced by reducing the width of a predetermined portion of the negative electrode lead 36 by a predetermined amount. In this embodiment, rather than forming notches and trenches in the current interrupter 36a, the width of the negative electrode lead 36 is reduced altogether.

Referring to FIG. 5E, the cross-sectional area of the current interrupter 36a is reduced by making the region of the negative electrode lead 36 where the current interrupter 36a is situated thinner. As can be seen in FIG. 5E, the region of the negative electrode lead 36, where the current interrupter 36a is situated, is thinner than the other portions of the negative electrode lead 36.

Referring to FIG. 5F, the cross-sectional area of the current interrupter 36a is reduced by forming a hole 36b in the current interrupter 36a. The hole 36b may have any shape and be of any size so long as the structural strength of the negative electrode lead 36 is not impaired. Thus, the size and shape of the hole 36b can be within a range which maintains the structural strength of the negative electrode lead 36.

It should be understood that the current interrupter 36a at the negative electrode lead 36, which reduces the cross-sectional area of the negative electrode lead 36, can be implemented using various methods in addition to the above-described methods. If the cross-sectional area of the current interrupter 36a is overly reduced, a structural strength of the negative electrode lead 36 may be weakened. However, if the cross-sectional area of the current interrupter 36a is insufficiently reduced, the desired disconnection in the case of an over-current, may not be caused. Thus, generally, the cross-sectional area of the current interrupter 36a is about 0.2 to about 0.9 times that of an adjacent portion of the negative electrode lead 36. The appropriate range of the cross-sectional area of the current interrupter 36a can be determined in consideration of a capacity of a cell and the characteristics of materials used.

As described above, the current interrupter 36a, which is a region of the negative electrode lead 36, causes a disconnection when there is an increase in resistance. Thus, it is important to select an appropriate material for the current interrupter 36a. Materials, such as, copper, nickel or an alloy thereof may be used.

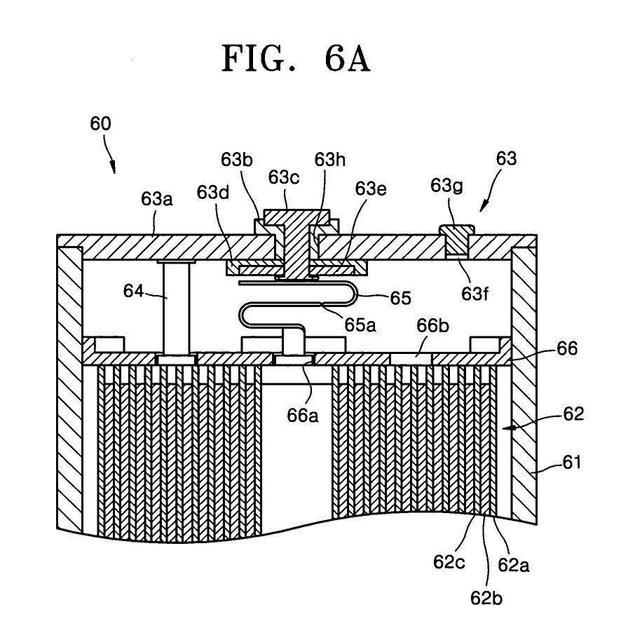

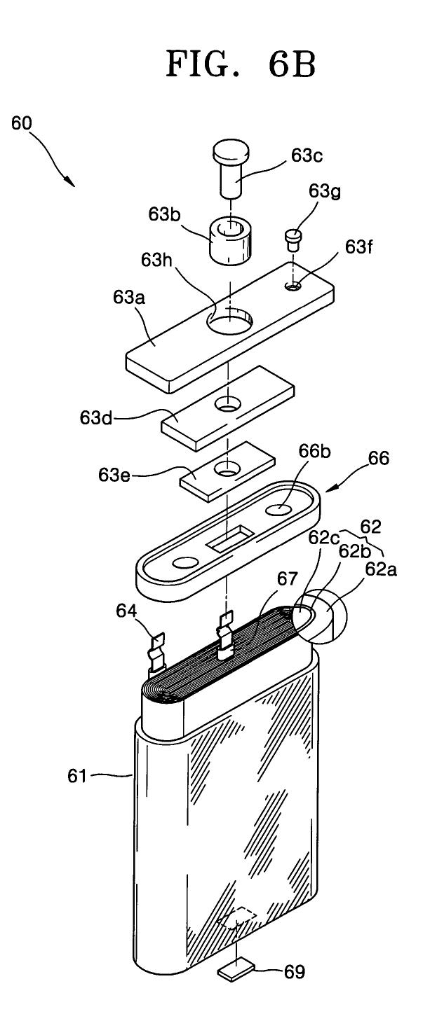

FIG. 6A is a cross-sectional view of a lithium ion cell having a rectangular can according to this invention and FIG. 6B is an exploded perspective view thereof. Referring thereto, the lithium ion cell 60 includes a can 61, a battery unit 62 which is accommodated inside the can 61, and a cap assembly 63 which is connected to the upper portion of the can 61.

The can 61 may be made of a hollow, rectangular metal material and is capable of serving as a terminal. A safety vent 69 is installed on the bottom surface of the can 61. The safety vent 69 brakes faster than other portions of the can 61 when the internal pressure of the can 61 increases due to abnormality of the lithium ion cell 60. The safety vent 69 may be, for example, a plate which is thinner than the thickness of the can 61, which covers a through-hole formed at the bottom of the can 61.

The battery unit 62 which is accommodated inside the can 61 includes a positive electrode plate 62a, a negative electrode plate 62c and a separator 62b. The positive electrode 62a, the negative electrode plate 62c and the separator 62b are formed of strips or sheets of material. The positive electrode plate 62a, the separator 62b and the negative electrode plate 62c are sequentially stacked and wound to form the battery unit.

The positive electrode plate 62a includes a positive electrode current collector made, for example, of a thin aluminum foil, and a positive electrode active material coated thereon. The positive electrode active material has, for example, a lithium oxide as a main component and coats both surfaces of the positive electrode current collector. A positive electrode lead 64 is welded to the positive electrode plate 62a at an electrode uncoated area of a positive electrode current collector. The electrode uncoated area of the positive electrode current collect is the region of the positive electrode current collector where a positive electrode active material layer is not coated thereon. The positive electrode lead 64 protrudes upward with respect to the battery unit 64.

The negative electrode plate 62c includes a negative electrode current collector made, for example, of a thin copper foil and a negative electrode active material layer coated thereon. The negative electrode active material layer has, for example, a carbon material as a main component and coats both surfaces of the negative electrode active material layer. A negative electrode lead 65 is welded to the negative electrode plate 62c at an electrode uncoated area of a negative electrode current collector. The electrode uncoated area of the negative electrode current collector is the region of the negative electrode current collector where a negative electrode active material layer is not coated thereon. The current interrupter 65a is provided at a predetermined area of the negative electrode lead 65.

Here, the positive electrode lead 64 and the negative electrode lead 65 may be disposed so as to have different polarities. An insulating tape 67 is wrapped around a portion of the battery unit 62 from which the positive electrode lead 64 and the negative electrode lead 65 protrude out. The insulating tape 67 is for the purpose of preventing disconnection between the positive electrode plate 62a and the negative electrode plates 62c.

The separator 62b is formed, for example, of a composite film of polyethylene and polypropylene. Generally, the separator 62b is wider than the positive electrode plate 62a or the negative electrode plate 62c to help prevent short-circuiting between the positive electrode plate 62a and the negative electrode plate 62c.

A cap plate 63a is provided at the cap assembly 63 which is connected to the upper portion of the can 61. The cap plate 63a is made, for example, of a metal material which is in the shape of a flat panel with a size and a shape which correspond to the size and the shape of an opening of the can 61. A terminal through-hole 63h having a predetermined size may be formed at the center of the cap plate 63a. Also, an electrolytic solution inlet 63f may be formed at one side of the cap plate 63a. A ball 63g may be coupled to the electrolytic solution inlet 63f such that the ball seals the inlet 63f.

An electrode terminal, e.g., a negative electrode terminal 63c, is positioned at the terminal through-hole 63h so as to be inserted therein. A tubular gasket 63b may be installed on the outer surface of the negative electrode terminal 63c for insulating the negative electrode terminal 63c and the cap plate 63a. An insulating plate 63d may be installed beneath the cap plate 63a and a terminal plate 63e may be installed beneath the insulating plate 63d.

In a state in which the outer surface of the negative electrode terminal 63c is wrapped by the gasket 63b, the negative electrode terminal 63c is inserted into the terminal through-hole 63h. The bottom portion of the negative electrode terminal 63c is exposed below the cap plate 63a, which is connected with the can 61. The negative electrode terminal 63c is connected with the cap plate 63a such that it is fixed with respect to the cap plate 63a and the insulating plate 63d and the terminal plate 63e are in position. The bottom portion of the negative electrode terminal 63c is electrically coupled to the terminal plate 63e.

Above the battery unit 62 an insulating case 66 is installed. The insulating case 66 electrically insulates the battery unit 62 from the cap assembly 63 and provides a passage for the flow of an electrolytic solution. Electrolytic solution may be injected through the electrolytic solution inlet 63f. The insulating case 66 may be made, for example, of a polymer resin which has an insulating property, such as, polypropylene.

It should be understood that the above-described construction can also be applied to a lithium ion cell having a cylindrical can.

As described above, in the electrode assembly of a lithium ion cell and a pouch-type battery using the electrode assembly according to this invention, a low-viscosity tape is used in forming the electrode assembly. The low-viscosity tape helps prevent distortion in the event of swelling of the cell, thereby improving the performance and lifetime characteristics of the cell. Thus, a more reliable lithium ion cell is attained.

While the present invention has been particularly shown and described with reference to preferred exemplary embodiments thereof, it will be understood by those of ordinary skill in the art that various changes in form and details may be made therein without departing from the spirit and scope of the present invention as defined by the following claims.

What is claimed is:

1. An electrode assembly for a lithium ion cell, comprising:
a battery unit having a positive electrode plate, a separator and a negative electrode plate which are sequentially stacked and wound;
a positive electrode lead that is electrically coupled to the positive electrode plate and is led from the positive electrode plate; and
a negative electrode lead that is electrically coupled to the negative electrode plate and has a current interrupter which causes disconnection when an over-current flows.

2. The electrode assembly of claim 1, wherein the current interrupter is led from the negative electrode plate and has a cross-sectional area which is smaller than a cross-sectional area of an adjacent portion of the negative electrode lead.

3. The electrode assembly of claim 1, wherein the cross-sectional area of the current interrupter of the negative electrode lead is reduced by forming notches opposite to one another along both edges of the current interrupter.

4. The electrode assembly of claim 2, wherein the cross-sectional area of the current interrupter of the negative electrode lead is reduced by forming trenches opposite to one another across two surfaces of the current interrupter.

5. The electrode assembly of claim 2, wherein the cross-sectional area of the current interrupter of the negative electrode lead is reduced by making the thickness of the current interrupter smaller than that of an adjacent portion of the negative electrode lead.

6. The electrode assembly of claim 2, wherein the cross-sectional area of the current interrupter of the negative electrode lead is reduced by forming a hole in the negative electrode lead.

7. The electrode assembly of claim 2, wherein the cross-sectional area of the current interrupter is about 0.2 to about 0.9 times that of an adjacent portion of the negative electrode lead.

8. The electrode assembly of claim 1, wherein the negative electrode lead is made of copper.

9. The electrode assembly of claim 1, wherein the negative electrode lead is made of nickel.

10. A lithium ion cell, comprising:
an electrode assembly for a lithium ion cell comprising a battery unit having a positive electrode plate, a separator and a negative electrode plate which are sequentially stacked and wound, a positive electrode lead that is electrically coupled to the positive electrode plate and is led from the positive electrode plate, and a negative electrode lead that is electrically coupled to the negative electrode plate and has a current interrupter which causes disconnection when an over-current flows;
a can, the can accommodates the electrode assembly; and
a cap plate welded to an upper end of the can and having a negative electrode terminal electrically coupled to the negative electrode lead of the electrode assembly.

11. The lithium ion cell of claim 10, wherein the can is cylindrical.

12. The lithium ion cell of claim 10, wherein the can is rectangular.

13. The lithium ion cell of claim 11, wherein the current interrupter is led from the negative electrode plate and has a cross-sectional area that is smaller than that of an adjacent portion of the negative electrode lead.

14. The lithium ion cell of claim 12, wherein the current interrupter is led from the negative electrode plate and has a cross-sectional area that is smaller than that of an adjacent portion of the negative electrode lead.

15. The lithium ion cell of claim 13, wherein the cross-sectional area of the current interrupter of the negative electrode lead is reduced by forming notches opposite to one another along both edges of the current interrupter.

16. The lithium ion cell of claim 14, wherein the cross-sectional area of the current interrupter of the negative electrode lead is reduced by forming notches opposite to one another along both edges of the current interrupter.

17. The lithium ion cell of claim 13, wherein the cross-sectional area of the current interrupter of the negative electrode lead is reduced by forming trenches opposite to one another across two surfaces of the current interrupter.

18. The lithium ion cell of claim 14, wherein the cross-sectional area of the current interrupter of the negative electrode lead is reduced by forming trenches opposite to one another across two surfaces of the current interrupter.

19. The lithium ion cell of claim 13, wherein the cross-sectional area of the current interrupter of the negative electrode lead is reduced by making the thickness of the current interrupter smaller than that of an adjacent portion of the negative electrode lead.

20. The lithium ion cell of claim 14, wherein the cross-sectional area of the current interrupter of the negative electrode lead is reduced by making the thickness of the current interrupter smaller than that of an adjacent portion of the negative electrode lead.

21. The lithium ion cell of claim 13, wherein the cross-sectional area of the current interrupter of the negative electrode lead is reduced by forming a hole in the negative electrode lead.

22. The lithium ion cell of claim 14, wherein the cross-sectional area of the current interrupter of the negative electrode lead is reduced by forming a hole in the negative electrode lead.
